(19) United States
(12) Patent Application Publication
(10) Pub. No.: US 2007/0116499 A1
(43) Pub. Date: May 24, 2007

(54) External heater rollers for fuser surface cleaning

(75) Inventors: John E. Derimiggio, Fairport, NY (US); Paul Fromm, Rochester, NY (US)

Correspondence Address: JAMES J. RALABATE, 5792 MAIN STREET, WILLIAMSVILLE, NY, 14221, US

(73) Assignee: Xerox Corporation

(21) Appl. No.: 11/286,941

(22) Filed: Nov. 23, 2005

(51) Int. Cl. G03G 15/20

(52) U.S. Cl. 399/327

(57) ABSTRACT

This provides an electrophotographic system having heat rollers that have roughened surfaces capable of cleaning debris from the surface of the fuser roll. This debris can be removed from the system by paper in subsequent contact with the fuser roll containing residual debris.

### FIELD

This invention relates, generally, to image-forming machines and methods and, more specifically, to the fusing systems in an electrophotographic reproduction machine.

### BACKGROUND

Electrophotographic image-forming machines are used to transfer images onto paper or other medium in both printing and facsimile systems. Generally, a photoconductor is selectively charged and optically exposed to form an electrostatic latent image on the surface. Toner is deposited onto the charged photoconductor surface. The toner has a charge, thus it will adhere to the photoconductor surface in areas corresponding to the electrostatic latent image. The toner image is transferred to the paper or other medium. The toned paper is heated by a fuser roller system for the toner to fuse to the paper. The photoconductor is then refreshed—cleaned to remove any residual toner and charge—to make it ready for another image. The imaged paper is then passed to a document output collection area or tray where the user collects the finished, permanently imaged paper or documents.

The fuser roll used in this fuser roller system eventually becomes contaminated with a film or debris containing by-products of toner and others, including silicone contaminants and metal salts. This contamination usually takes the form of a hard film which eventually builds up and adversely affects the performance of the fuser roll.

While this fuser roll contamination can occur in any electrophotographic printer or copier, it causes more image quality defects in color or multi-function copiers. Generally, the fuser roll becomes contaminated, as earlier noted, with by-products of fuser chemical reactions which eventually cause early failure of the fusing system and fuser roll. Sometimes, this problem is solved with modifications of the fuser material set (fuser release fluids, toner, etc.). These modifications can be complicated, are not always successful and typically have a long cycle time to become effective and to implement. Other times, there is no practical solution to this fuser roll contamination due to competing effects of control factors.

Problems with debris on the fuser roller can eventually affect the pressure roll and the quality and clarity of the imaged paper in contact with the fuser roller. Also, the life of the relatively expensive fuser roll can be substantially shortened if this contamination problem is not addressed.

### SUMMARY

In a high speed printer fuser system, the fuser roll is usually contacted by two external heat rolls which have, as their primary object, the transfer of heat to the fuser roll. At one location, these external heat rolls are in contact with the fuser roll and, at a different location, they are in contact with a web that cleans these external heat rolls.

This web usually is made from NOMEX (a trademark of DuPont Corporation). In some instances, the contamination of the fuser roll is eventually transferred to the cleaning web and could lessen its intended purpose or effectiveness. The fuser rolls are usually made from a fluro-elastomer coated with VITON (a trademark of DuPont Corporation). The external heat rolls, generally, have an aluminum anodized surface which contacts substantially the entire width fuser roll surface during the fusing operation or step.

The fusing system in an embodiment comprises, in operative relationship, a fuser roll, at least one external heat roll and a pressure roll. The fuser roll is in operative contact with the external heat roll(s) during the fusing step. The external heat roll(s) has a predetermined surface roughness which will clean any surface contamination film or debris from the surface of the fuser roll when in contact therewith in a cleaning step and/or during the fusing step. This roughness on the surface of the heat roll is a random roughness like sandpaper or is a designed or patterned roughness. This pattern roughness can be created on the surface of the heat roll by etching, laser, mechanical designing or any other suitable method. When the roughness is random, this random roughness is equivalent to from about a two (2) to about a fifteen (15) micron R. A. (Roughness Average) as determined by industry standards. Both the random and patterned roughness will remove surface contamination from the fuser roll and will improve the print quality of the imaged paper or receiving medium. Also, it will extend the life of the relatively expensive fuser roll. The roughened external heat rolls will also use its relative motion or creep against the fuser roll to enhance the cleaning process.

The debris or film removed from the fuser roll can later be collected in the system for disposal. It is important that the surface roughness on the heating rolls be predetermined to be enough to remove the debris and yet not unduly abrade the surface of the fuser roll. The fuser roll should be substantially the same length as the external heat roll(s) for a maximum cleaning function on all parts of the fuser roll surface.

The fusing roll at a first location is in operative contact with the pressure roll and is in operative contact at a second location with the external heat roll or rolls. The patterned roughness can be of any suitable pattern including grooves, projections, pits, indentations, holes, sinusoidal waves, scrapers and mixtures thereof.

### BRIEF DESCRIPTION OF THE DRAWINGS

FIG. 1 is an illustration of an embodiment of the partial system used in an electrophotographic apparatus.

FIG. 2 illustrates an embodiment of a patterned roughness on the external heater roll(s) where the pattern includes longitudinal grooves.

FIG. 3 illustrates an embodiment of a patterned roughness on the external heat roll(s) where the pattern includes holes or projections.

FIG. 4 illustrates an embodiment of a patterned roughness on the external heat roll(s) where the pattern includes a sinusoidal wave.

FIG. 5 illustrates an embodiment of a random roughness on the external heat roll(s).

### DETAILED DISCUSSION OF DRAWINGS AND PREFERRED EMBODIMENTS

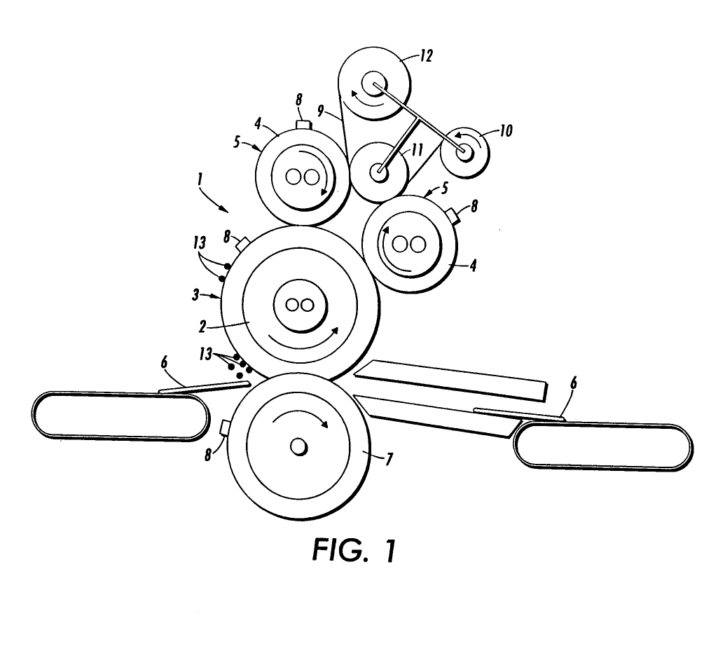

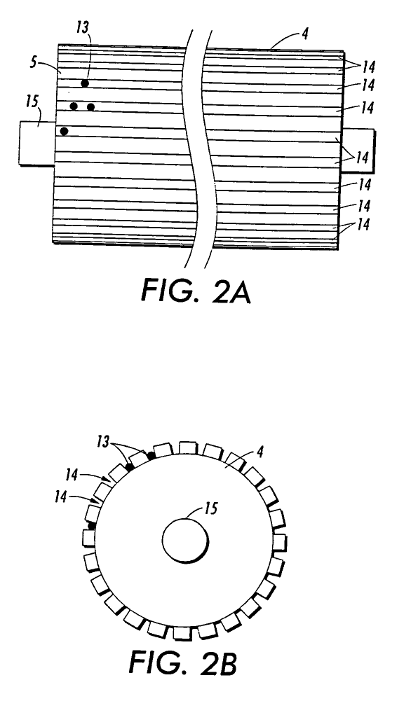

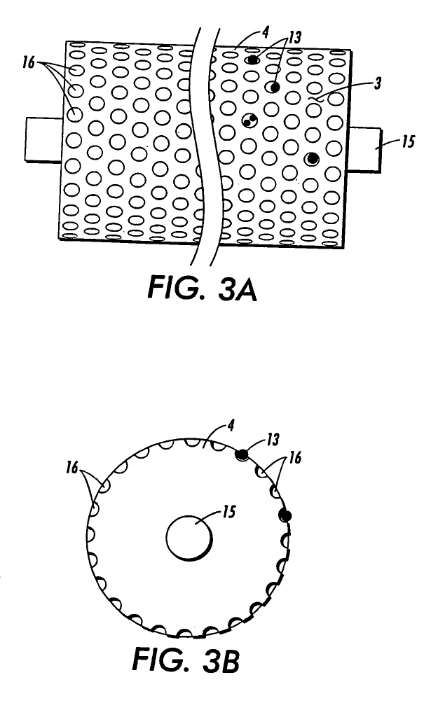

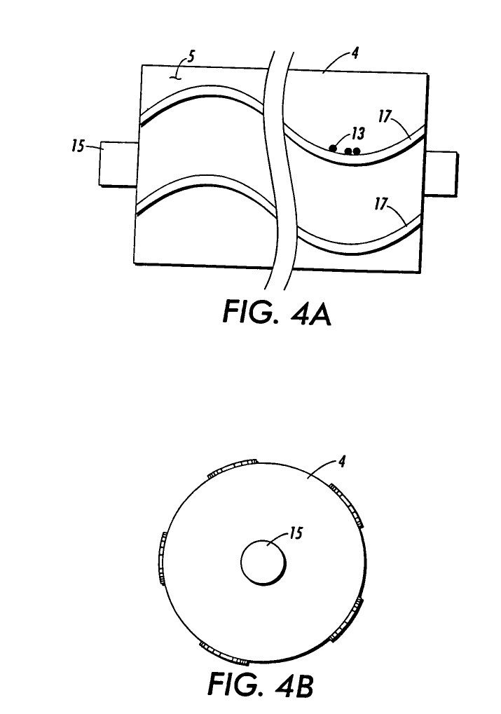

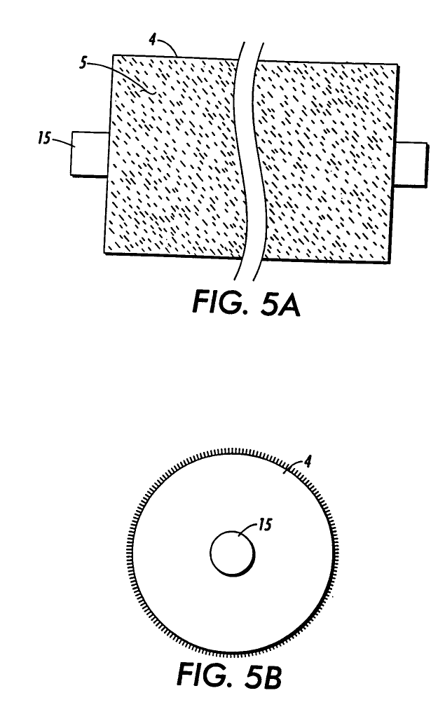

In FIG. 1, a partial electrophotographic system 1 is shown; for clarity the entire system need not be illustrated. Shown is fuser roll 2 generally having a soft elastomeric surface 3. This surface 3 eventually becomes coated with toner contaminants or debris which eventually renders the fuser roll 2 less effective. Also, this coating shortens the life of the fuser roll which is relatively expensive. To remove these contaminants from the surface 3 of the fuser roll 2, the surface 5 of heater rolls 4 is roughened enough to remove the film or contaminants without damaging or abrading the fuser roll surface 3. During a fusing step, toned paper 6 is passed between fuser roll 2 and pressure roll 7 where the toner is fused to the receiving sheets of paper 6. The fuser roll 2 is heated by heater rolls 4 and the heat is maintained by controlling the thermistor or thermistors 8 which is positioned on fuser roll 2 and heater rolls 4 so that they will not interfere with the rotation of fuser roll 2, pressure roll 7 and heater rolls 4. This can be accomplished by putting thermostats 8 on the ends of the rolls. A web 9 contacts the heater roll surface 5 to clean the surfaces 5. Sometimes the contamination of fuser roll surface 3 is transferred to web 9 and interferes with web 9 cleaning function. If surface 3 of fuser roll 2 is kept clean, web 9 will also benefit from this cleaning action. The web 9 is supplied by web supply 10, it passes to web nip roll 11 where the web 9 is put in contact with and cleans external heat rolls 4. The web 9 then passes to web take up roll 12 where it can be rewound. In this embodiment, external heat rolls 4 now have two functions—to transfer heat to the fuser roll 2 and second, to scrub or clean the debris film or contamination off fuser roll surface 3 via stain induced relative motion. Heater rolls 4 can be at a normal rotational speed or a drag or increased torque can be put on these rollers to give them an enhanced cleaning function. As the debris 13 from the film on the surface 3 is dislodged from surface 3, it will fall and be collected by any suitable means, for example, the loosened material is cleaned off the heater rolls by the web, or the web contacts the fuser roll directly to lift off the loose debris. As earlier noted, the roughened surface 5 of heater rolls 4 can be patterned or random. FIGS. 2-4 illustrate some embodiments or designs of patterned rough surface 5 and FIG. 5 illustrates an embodiment for a random roughness. In FIG. 2, longitudinal grooves 14 may be etched, scratched or otherwise placed on the entire surface 5 of heater rolls 4. The debris 13 will be dislodged and fall within grooves 14 when the fuser roll surface 3 is cleaned by roughened surface 5 of heat rolls 4. Axles 15 impart rotational motion to all of the heat rolls 4. In FIG. 3, a heating roll 4 is shown having pits or holes 16 in surface 3 of heating roll 4. The debris 13 will be dislodged from fuser roll 2 and caught in apertures or holes 16. In FIG. 4, a curved scraping or sinusoidal surface 17 is placed on surface 5 of heater rolls 4. The debris 13 will be caught in curved portions of sinusoidal surface 17. In FIG. 5, a heat roll 4 is illustrated having a random roughness on surface 5. This roughness is from about 2 to about 15 micron R. A. In one embodiment, this loosened debris is cleaned from the external rolls via rubbing against the web.

The preferred and optimally preferred embodiments of the present invention have been described herein and shown in the accompanying drawings to illustrate the underlying principles of the invention, but it is to be understood that numerous modifications and ramifications may be made without departing from the spirit and scope of this invention.

1-24. (canceled)

25. A fusing system used in an electrophotographic imaging apparatus comprising in an operative relationship, at least one external heat roll, a fuser roll, a pressure roll, and a web cleaning belt, said web cleaning belt enabled to clean said external heat rolls, said fuser roll in operative contact at a first location with said pressure roll, said fuser roll in operative contact at a second location(s) with said external heat roll(s), said external heat rolls having two functions, to transfer heat to the fuser roll and to scrub or clean the debris or contamination from the fuser roll surface, said external heat roll having a predetermined surface roughness extending throughout its length and having substantially a same length as said fuser roll, and enabled to contact substantially the entire length of said fuser roll and enabled to effectively remove debris on substantially any portion of the surface of said fuser roll in a cleaning step, said predetermined surface roughness selected from the group consisting of a random roughness, a patterned roughness and mixtures thereof, and wherein debris dislodged from said fuser roll is disposed of after cleaning of the fuser roll by said external heat rolls.

26. The fusing system of claim 25 wherein said surface roughness on said external heat rolls is predetermined and controlled so as to effectively remove said debris from said fuser surface by said external heat rolls without causing undue wear and abrasion of said fuser roll surface.

27. The fusing system of claim 25 wherein said surface roughness of said external heat roll is a random roughness equivalent to from about 2 to about 15 micron R. A. (roughness average).

28. The fusing system of claim 25 wherein said surface roughness is a patterned roughness wherein said pattern is selected from the group consisting of grooves, projections, pits, indentations, holes, sinusoidal waves, scrapers and mixtures thereof.

29. The fusing system of claim 25 wherein said debris is removed from said fuser roll at said second location and subsequently removed from said system.

30. The fusing system of claim 25 wherein said debris is dislodged from said fuser roll by contact with said external heating roll and is subsequently discarded from said system.
